(19) United States
(12) Patent Application Publication
(10) Pub. No.: US 2009/0232344 A1
(43) Pub. Date: Sep. 17, 2009

(54) Speaker

(76) Inventor: Osamu Funahashi, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/658,913

(22) PCT Filed: Sep. 20, 2006
(86) PCT No.: PCT/JP2006/318562

§ 371 Date: Jan. 30, 2007

(30) Foreign Application Priority Data
Sep. 28, 2005 (JP) 2005-281764

(51) Int. Cl. H04R 1/00

(52) U.S. Cl. 381/412

(57) ABSTRACT

The frame of a speaker is divided into a first frame part and second frame part. The outer circumferential edge of the suspension holder is sandwiched between the surfaces of the first and second frame parts. This structure can reduce rolling of the diaphragm and harmonic distortion of the speaker.

### TECHNICAL FIELD

The present invention relates to the structure of a speaker.

### BACKGROUND ART

FIG. 4 is a section of a conventional speaker. Voice coil 22 is disposed in the gap of magnetic circuit 21. The inner circumferential edge of diaphragm 23 is connected to voice coil 22. The outer circumferential edge of diaphragm 23 is coupled to frame 25 via edge 24. The backside of diaphragm 23 is coupled to frame 25 via suspension holder 26 and edge 27. The symmetrical structure of edges 24 and 27 allows diaphragm 23 to vibrate as symmetrically as possible in the vertical direction, thus reducing distortion of the speaker. This conventional art is disclosed in Japanese Patent Unexamined Publication No. 2004-7332, for example.

However, in the conventional speaker, ring-shaped edge 27 has diameter a smaller than diameter b of ring-shaped edge 24; thus, the speaker cannot eliminate harmonic distortion sufficiently.

### SUMMARY OF THE INVENTION

A speaker of the present invention includes: a frame; a magnetic circuit disposed in the frame; a voice coil disposed movably with respect to the magnetic gap in the magnetic circuit; a diaphragm having an inner circumferential edge connected to the voice coil, and an outer circumferential edge coupled to the frame via a first edge; and a suspension holder connected to the backside of the diaphragm and having an outer circumferential edge coupled to the frame via a second edge. The frame has a block construction including a first frame part and a second frame part. The outer circumferential edge of the second edge is sandwiched between the first and second frame parts. This structure largely eliminates harmonic distortion of the speaker.

### BRIEF DESCRIPTION OF THE DRAWINGS

FIG. 1 is a part of a section of a speaker in accordance with an exemplary embodiment of the present invention.

FIG. 2 is a section of a frame of the speaker shown in FIG. 1.

FIG. 3 is a part of a section of a speaker in accordance with another exemplary embodiment of the present invention.

FIG. 4 is a part of a section of a conventional speaker.

### REFERENCE MARKS IN THE DRAWINGS

1 Magnetic circuit
2 Voice coil
3 Diaphragm
4 First edge
6 Suspension holder
7 Second edge
8 Magnetic gap
10 Frame
10a First frame part
10b Second frame part

### DETAILED DESCRIPTION OF PREFERRED EMBODIMENTS

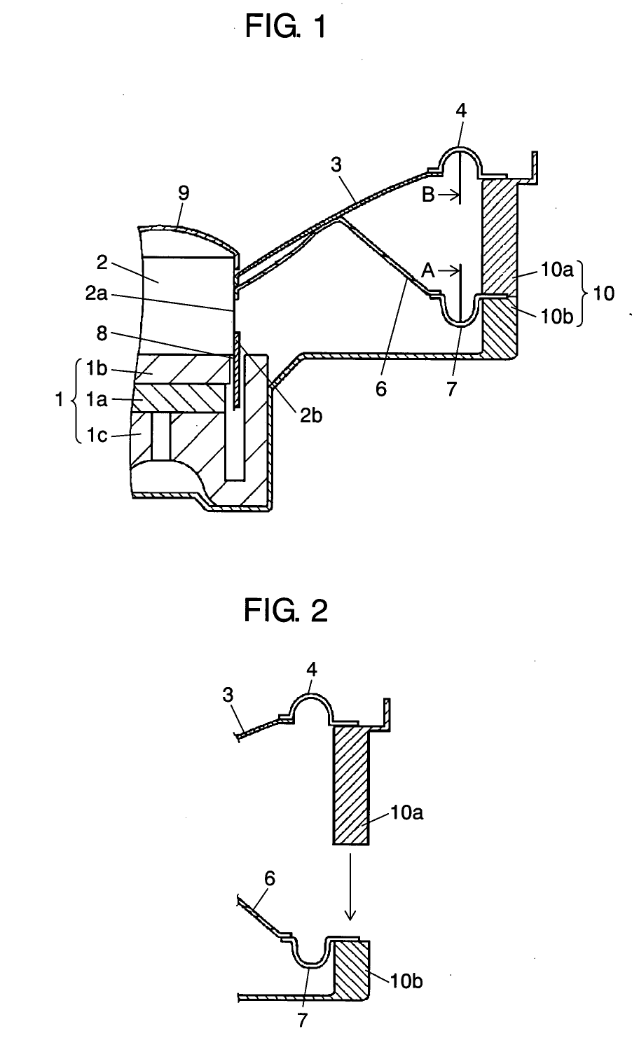

Hereinafter, a description is provided of exemplary embodiments of the present invention, with reference to the accompanying drawings. FIG. 1 is a section of a speaker in accordance with an exemplary embodiment of the present invention.

Magnetic circuit 1 is disposed in the center of the bottom of frame 10. Magnetic circuit 1 includes disk-shaped magnet 1a, disk-shaped plate 1b, cup-shaped yoke 1c, and magnetic gap 8 formed between plate 1b and the sidewall of yoke 1c.

Voice coil 2 includes cylindrical bobbin 2a, coil 2b wounded around cylindrical bobbin 2a, and dust cap 9. Coil 2b is inserted into magnetic gap 8. Voice coil 2 is disposed vertically movable with respect to magnetic gap 8 to vibrate diaphragm 3, i.e. the sound source of the speaker, connected along the outer circumference of bobbin 2a. The outer circumferential edge of diaphragm 3 is coupled to the open end of frame 10 via first edge 4. The inner circumferential edge of diaphragm 3 is connected to voice coil 2. First edge 4 is made of a material capable of preventing a dynamic load from being imposed on diaphragm 3, such as urethane, expanded rubber, styrene-butadiene rubber (SBR), and cloth.

The outer circumferential edge of suspension holder 6 is coupled to frame 10 via second edge 7. The middle portion of suspension holder 6 is integrated with the backside of the middle portion of diaphragm 3 by bonding. Then, the inner circumferential edge of suspension holder 6 is fixed to voice coil 2 together with the inner circumferential edge of diaphragm 3.

Suspension holder 6 is a mass added to diaphragm 3 and thus decreases efficiency of the speaker. For this reason, preferably, the suspension holder is as light as possible, and made of pulp or resin. Second edge 7 is made of a material capable of preventing a dynamic load from being imposed on diaphragm 3 and suspension holder 6, such as urethane, expanded rubber, SBR rubber, and cloth.

Placing the junction point of voice coil 2 and diaphragm 3, and the junction point of voice coil 2 and suspension holder 6, i.e. the driving points, within the area surrounded by first edge 4 and second edge 7, i.e. both fulcrums connected to frame 10, can provide a structure capable of inhibiting rolling of diaphragm 3 and harmonic distortion.

First edge 4 and second edge 7 are both ring-shaped. First edge 4 projects upward, and edge 7 projects downward. Thus, both edges have symmetrical shapes or symmetrical amplitude characteristics with respect to each other.

As shown in FIG. 2, cylindrical frame 10 is divided into upper frame 10a (first frame part) and lower frame 10b (second frame part). First edge 4 is connected to upper frame 10a, and second edge 7 is connected between frame 10a and frame 10b. This structure can largely inhibit harmonic distortion of the speaker.

In other words, dividing frame 10 into upper frame 10a and lower frame 10b makes diameter B of ring-shaped edge 4 and diameter A of ring-shaped edge 7 equal to each other and ensures symmetry of edges 4 and 7. This structure can improve amplitude symmetry, and further reduce harmonic distortion of the speaker.

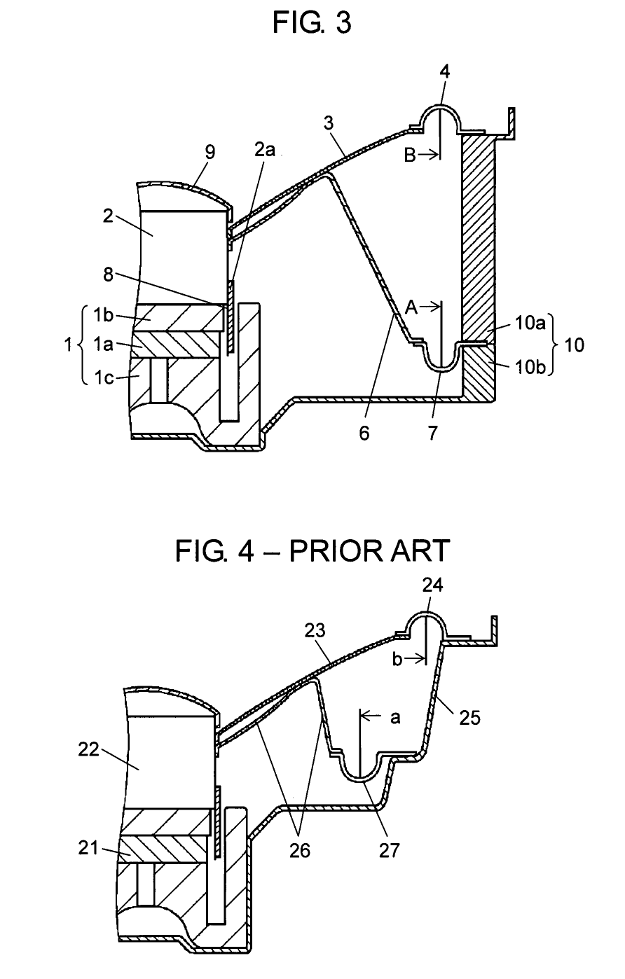

Further, as shown in FIG. 3, the position in which frames 10a and 10b sandwich second edge 7 is set below the upper end of magnetic circuit 1. This setting allows magnetic gap 8 for generating driving force of voice coil 2, the junction point of diaphragm 3 and voice coil 2, and the junction point of suspension holder 6 and voice coil 2, i.e. the driving points, to be disposed within the area surrounded by first edge 4 and second edge 7 both forming fulcrums. This structure can reduce rolling of diaphragm 3 and harmonic distortion of the speaker more efficiently.

### INDUSTRIAL APPLICABILITY

The present invention inhibits distortion of a speaker, and thus is particularly useful to high-power speakers.

1. A speaker comprising:
a frame;
a magnetic circuit disposed in the frame;
a voice coil disposed movably with respect to the magnetic gap in the magnetic circuit;
a diaphragm having an inner circumferential edge coupled to the voice coil, and an outer circumferential edge coupled to the frame via a first edge; and
a suspension holder coupled to a backside of the diaphragm and having an outer circumferential edge coupled to the frame via a second edge,
wherein, the frame has a block construction including a first frame part and a second frame part, and an outer circumferential edge of the second edge is sandwiched between the first and second frame parts.

2. The speaker of claim 1, wherein the frame is divided in a position set below an upper end of the magnetic circuit.

3. The speaker of claim 1, wherein the first and second edges have one of a symmetrical shape and symmetrical amplitude characteristics.

4. The speaker of claim 2, wherein the first and second edges have one of a symmetrical shape and symmetrical amplitude characteristics.
